(19) United States
(12) Patent Application Publication
(10) Pub. No.: US 2008/0247092 A1
(43) Pub. Date: Oct. 9, 2008

(54) STORAGE DISK DRIVING APPARATUS FOR DRIVING A STORAGE DISK AND A CASE THEREFOR

(75) Inventors: Hiroshi Minami, Kawasaki (JP); Hideaki Kamezawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/029,910

(22) Filed: Feb. 12, 2008

(30) Foreign Application Priority Data
Feb. 28, 2007 (JP) 2007-48454

(51) Int. Cl. G11B 5/48

(52) U.S. Cl. 360/244

(57) ABSTRACT

A storage disk driving apparatus for driving a storage disk includes a carriage holding a head slider at the tip of the carriage. A shroud surface is disposed upstream of an air flow generated by the rotation of the storage disk with respect to the carriage, such that a plane surface extending in parallel with an outer edge line of the storage disk and away from the outer edge of the storage disk downstream of the air flow. In this manner, the air is directed more towards the axis of the carriage, and away from the arms of the carriage.

### BACKGROUND

1. Field

The present technique relates to, for example, a driving apparatus for driving a storage disk such as a hard disk drive (HDD), and in particular a storage disk driving apparatus comprising at least a storage disk and a shroud surface facing the outer edges of the storage disk.

2. Description of Related Art

As disclosed in Japanese Patent Application Laid-Open No. 2004-234784, for example, in a conventional hard disk drive (HDD) a shroud surface faces the outer edge surface of the magnetic disks with a predetermined gap. The shroud surface is defined by a certain cylindrical surface. While the magnetic disks are rotating, air flow is generated along the magnetic disks. Disturbance of the air flow is limited by the function of the shroud surface. The vibration of the magnetic disks is reduced, too.

In HDD, a carriage supporting floating head sliders is built-in. The carriage has a main carriage block connected to a main axis so as to freely rotate. Carriage arms extend from the carriage along planes crossing the main axis orthogonally. The floating head sliders are to be positioned on target recording tracks on the magnetic disks based on the carriage's vibration generated by the spin of the main axis. Further examples are seen in Japanese Patent Application Laid-Open Nos. 2003-85941, 2002-184154, and 2002-109843.

When the floating head sliders move from the outer tracks on magnetic disks to the inner tracks near the spin axis of the same, the cross-angle increases between the centerline of the carriage, that is, the lines extending from the main axis to the tip of the carriage, and the direction of the air flow. When the floating head sliders are positioned on the inner side of the magnetic disks, the air flow blows against the carriage arms. Such vibration deteriorates the positioning accuracy of the floating head sliders.

In view of such circumstances, an object of the present technique is to provide a storage driving apparatus for driving a storage disk and a case for the same, that reduces such deterioration of the positioning accuracy of a head slider.

### SUMMARY

A storage disk driving apparatus for driving a storage disk includes a carriage holding a head slider at the tip of the carriage, and a shroud surface disposed on upstream of an air flow generated by the rotation of the storage disk than the carriage. The shroud surface is comprised of a plane surface extending in parallel with an outer edge line of the storage disk and away from the outer edge of the storage disk downstream of the air flow generated by the rotation of the storage disk.

### BRIEF DESCRIPTION OF THE DRAWINGS

FIG. 1 is an outline plan view showing an inside structure of a storage disk driving apparatus according to a first embodiment.

FIG. 2 is an outline plan view of the driving apparatus of FIG. 1, showing the air flow when head sliders are disposed on inner sides of the storage disks.

FIG. 3 is an outline plan view showing an inside structure of a storage disk driving apparatus according a second embodiment.

### DETAILED DESCRIPTION OF THE EMBODIMENTS

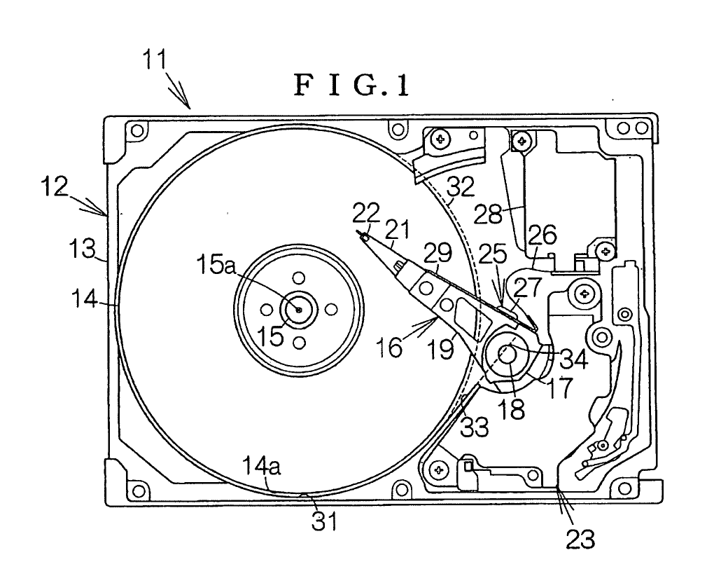

FIG. 1 shows the outline of an inside structure of a storage disk driving apparatus for driving a storage disk, namely a hard disk drive (HDD) 11, according to a first embodiment of the present technique. The HDD 11 includes a case, namely a housing 12. The housing 12 has a box-shaped main body, namely a base 13, and a cover (not shown). The base 13 defines, for example, a flat and rectangular inner-space, namely a housing space. The base 13 may be formed by casting of metal materials such as aluminum. The cover is attached to the opening of the base 13. The cover and the base 13 seal the housing space. The cover may be formed, for example, of a metal plate by pressing.

In the housing space one or more disks 14 as storage disks are disposed. The magnetic disks are attached to the spin axis of a spindle motor 15. In this way, the magnetic disks 14 rotate centering around the spindle motor 15, on a spin axis 15a. The spindle motor 15 can rotate the magnetic disks 14 at a high speed, for example, 3,600 rpm, 4,200 rpm, 5,400 rpm, 7,200 rpm, 10,000 rpm or 15,000 rpm and the like.

In the housing a space carriage 16 is further disposed. The carriage 16 includes a main carriage block 17. The main carriage block 17 is connected to a support axis 18 extending vertically so as to freely rotate. The support axis 18 is fixed on the bottom plate of the base 13, for example, by a screw (not shown). The main carriage block 17 has a plurality of carriage arms 19, extending horizontally along the planes crossing the support axis 18 orthogonally and distinct from the support axis 18. The main carriage block 17 may be formed, for example, of aluminum by extrusion.

Head suspensions 21 extend forward from the front tips of each carriage arm 19. On the front edges of the head suspensions 21, a flexure is bonded. On the flexure, floating head sliders 22 are supported. Based on the stiffness of the flexure, the floating head sliders can change the positioning thereof against the head suspensions 21 under the influence of air flow. On the floating head sliders 22, magnetic heads, namely electromagnetic conversion elements are mounted.

When the rotation of the magnetic disks 14 generates sufficient air flow over the surfaces of the magnetic disks 14, by the function of the air flow, positive pressure, namely buoyancy and negative pressure affect the mechanical floating head sliders 22. The total balance of buoyancy, minus pressure, and the pressure of the head suspensions 21 allows the head sliders 22 to keep floating with comparatively high rigidity while the magnetic disks 14 are rotating.

In floating of such floating head sliders 22, the carriage 16 swings around the support axis 18, and the floating head sliders 22 can move along the radius direction of the magnetic disks 14. As a result, the electromagnetic conversion elements on the floating head sliders 22 can move between the innermost recording tracks and the outermost recording tracks. In this way, the electromagnetic conversion elements on the floating head sliders 22 are positioned on target recording tracks. The main carriage block 17 is connected to a driving source, for example, a voice coil motor 23 (VCM). By the function of this VCM 23, the main carriage block 17 can rotate centering around the support axis 18. Based on such spin of the main carriage block 17, the swing of carriage arms 19 and the head suspensions 21 can be realized.

A flexible printed board unit 25 is disposed on the main carriage block 17. The flexible printed board unit 25 has a head IC (integrated circuit) 27 mounted on a flexible printed board unit 26. When reading magnetic information, the head IC 27 provides a sense current to reading head elements of the electromagnetic conversion elements. When writing magnetic information, the head IC 27 provides a write current to writing head elements of the electromagnetic conversion elements. The head IC 27 is provided with a sense or write current from a small circuit board 28 disposed in the housing space or a printed circuit board (not shown), which is displaced on the backside of the bottom plate of the base 13. A flexible printed board 29 is used for provision of such sense or write current. The flexible printed board 29 is connected to the flexible board unit 25.

At the outside of the magnetic disks 14, a main shroud surface 31 is defined by the base 13. The main shroud surface 31 extends in a virtual cylindrical space, coaxial with a cylindrical surface and surrounding the space. The axis of the virtual cylindrical space is coaxial with a spin axis 15a of the magnetic disks 14. Therefore, the main shroud surface 31 is placed to face an outer edge 14a of the magnetic disks 14 with a certain gap. In this embodiment, main shroud surface 31 extends seamlessly from downstream to upstream of the swing range of the carriage 16. The “upstream” and the “downstream” are defined by the direction of the air flow generated by the rotation of the magnetic disks 14.

A shroud surface 33 is placed continuously next to the main shroud surface 31. The shroud surface 33 is connected to the downstream edge of the main shroud surface. The shroud surface 33 faces the virtual cylindrical surface 32 from outside and more upstream side of the air flow generated by the rotation of the magnetic disks 14 than the position of the carriage 16.

The shroud surface 33 forms a plane surface extending away from the outer edges 14a downstream of the air flow generated by the rotations of the magnetic disks 14. The plane surface extends in parallel with the outer edge line based on a tangent of the magnetic disks 14 where the main shroud surface 31 meets the shroud surface 33. Coincidentally, the shroud surface 33 extends in parallel with the axis of the virtual cylindrical surface and in a virtual plane 34 making contact with the virtual surface 32 on the upstream end of the shroud surface 33. The virtual surface 34 crosses the main carriage block 17. The shroud surface 33 extends toward the main carriage block 17.

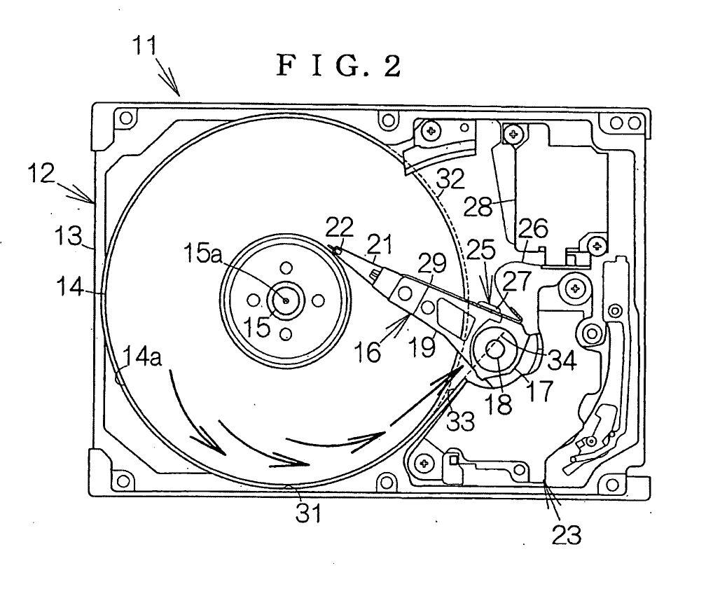

Such HDD 11 generates air flow along the surface of the magnetic disks 14 while the magnetic disks 14 are rotating. For example, as shown in FIG. 2, the air flow runs downstream directed by the rotations of the magnetic disks 14 while going away from a spin axis 15a of the magnetic disks 14. The outer edges 14a of the magnetic disks 14 face the main shroud surface 31 with a certain gap. The main shroud surface extends seamlessly from downstream to upstream of the swing range of the carriage 16. Such function of the main shroud 31 restrains the disturbance of the air flow and reduces the vibration of the magnetic disks 14.

By connecting the shroud surface 33 to the downstream edge of the main shroud surface 31, the air flow is directed from the main shroud surface 31 to the shroud surface 33. The shroud surface 33 runs away from the outer edge surface 14a downstream of the air flow generated by the rotations of the magnetic disks 14. As a result, the induced air flow blows against the main carriage block. By coupling the main carriage with the support axis, the vibration of the carriage 16 is restrained compared with an air flow that blows directly against carriage arms 19. In this way, the positioning accuracy of the floating head sliders 22 avoids deterioration, and the electromagnetic conversion elements are positioned on recording tracks more accurately than ever.

The other hand, inside of the conventional HDDs, the shroud surface keeps a certain gap facing the outer edge of the magnetic disks from upstream to downstream over the outside limit of the swing range of the carriage. As the floating head sliders move more towards the inner tracks of the magnetic disks, the cross angle between the center line of the carriage extending from the support axis to the tip of the carriage and the direction of the air flow becomes more perpendicular. As a result, the air flow blows against the carriage arms, and the positioning accuracy of the floating head sliders deteriorates. Therefore, the present technique has the effect of better positioning the floating head sliders on the inner side of the magnetic disks.

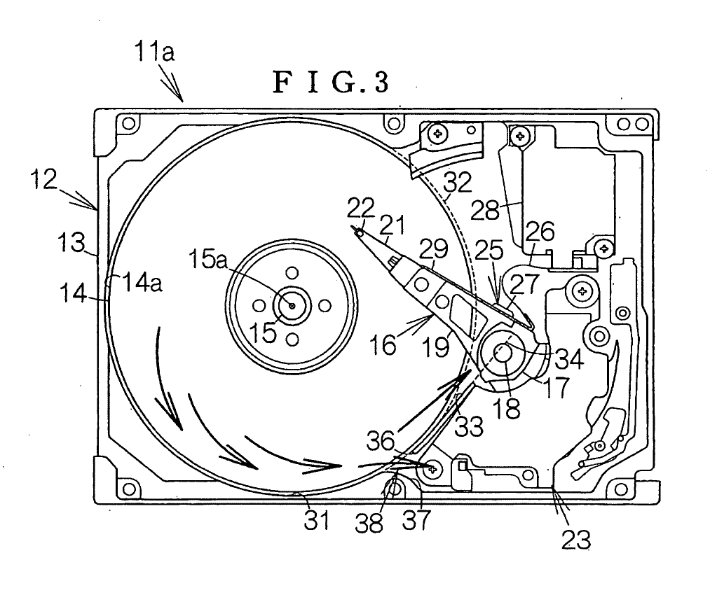

As shown in FIG. 3, in an HDD 11a according to a second embodiment of the present technique the main shroud surface 31 defines an opening, namely a vent 36. The main shroud surface ends at the vent 36. The upstream end of the vent may be disposed upstream of the downstream end of the main shroud surface 31. The main shroud surface 31 is connected to a guide wall 37 at the upstream end of the vent 36. The guide wall 37 is formed in the base 13. The guide wall 36 faces the VCM 23. In this way, the vent 36 is connected to an aisle 38 extending to the VCM 23. Other constitutions or structures which are equal in function to the above-described HDD 11 have the same referential marks.

In such HDD 11a, the air flow generated by the rotations of the magnetic disks is induced from the main shroud surface 31 to the vent 36. The induced air flow runs along the guide wall 37, so the vent 38 induces the air flow to the VCM 23 to restrain the temperature rise of the VCM 23. Concurrently, the shroud surface 33 induces the air flow to the main carriage block to restrain the vibration of the carriage 16 and avoid deteriorating of the positioning accuracy of the electromagnetic conversion elements. Furthermore, the vent 36 may be defined at the downstream end of the main shroud 31. In this way, the shroud surface 33 may be disposed distant from the cylindrical space.

As noted above, in the storage disk driving apparatus according to the present technique, the shroud surface may provide a plane surface extending away from the outer edge of the storage disks downstream of the air flow generated by the rotations of the storage disks. The shroud surface may be disposed upstream from the air flow generated by the rotations of the storage disks. As a result, the shroud surface adjusts the flow of air from the disk.

For example, the air flow is induced at the support axis of the carriage. Based on the swing of the carriage centering around the support axis, the positioning of the head sliders even on the innermost track of the storage disks does not affect the restriction from the carriage's vibration or the deterioration of the positioning accuracy of the head sliders.

Additionally, the carriage may have the main carriage block supported by the support axis and the carriage arms extending from the carriage block along the planes crossing the support axis orthogonally. In this way, by the function of the shroud surface, the air flow can be directed to the main carriage block. By supporting the main carriage block, the carriage's vibration is restrained when the air flow blows against the main carriage, so the deterioration of the positioning accuracy of the head sliders is reduced.

In addition, the shroud surface may extend in the virtual plane meeting the virtual cylindrical surface coaxial with the spin axis of the storage disks. The carriage may freely rotate and the carriage arms extending from the main carriage block along the planes cross the support axis orthogonally. The virtual plane may cross the main carriage block. In this way, the air flow can be directed to the main carriage block.

The main shroud surface may be disposed upstream of the shroud surface and extend in the virtual cylindrical surface defined as coaxial with the spin axis of the storage disks. Such function of the main shroud surface can restrain the disturbance of the air flow and deterioration of the positioning accuracy of the head sliders, and reduce the vibration of the storage disks. In this constitution, the shroud surface may make a continuum with the main shroud surface.

The storage disk driving apparatus described above may also have the vent connected to the aisle extending to the voice coil motor and defined by the voice coil motor connected to the carriage and the main shroud surface. In, the air flow generated over the surface of the storage disks can be directed from the main shroud surface to the vent. The induced air flow runs through the aisle created by the vent. As a result, the air flow can be directed to the voice coil motor to reduce the temperature rise of the motor.

Provided above, the present technique can provide a storage disk driving apparatus for a driving storage disk and a case therefor to reduce the deterioration of positioning accuracy of the head sliders caused by air flow.

What is claimed is:

1. A storage disk driving apparatus for driving a storage disk comprising:
a carriage holding a head slider at the tip of the carriage; and
a shroud surface disposed more upstream of an air flow generated by the rotation of the storage disk than the carriage, and comprised of a plane surface extending in parallel with an outer edge line of the storage disk and away from the outer edge of the storage disk downstream of the air flow generated by the rotation of the storage disk.

2. The storage disk driving apparatus according to claim 1, wherein the carriage comprises a main carriage block supported by the support axis so as to freely swing and a carriage arm extending from the main carriage block along a plane crossing the main axis orthogonally.

3. The storage disk driving apparatus according to claim 1, wherein the shroud surface extends in a virtual plane along a virtual cylindrical surface coaxial with the spin axis of the storage disk.

4. The storage disk driving apparatus according to claim 3, wherein the carriage comprises a main carriage block supported by the main axis so as to freely rotate and a carriage arm extending from the main block along the planes crossing the support axis orthogonally, and the virtual plane crosses the main carriage block.

5. The storage disk driving apparatus according to claim 3, wherein the shroud surface further comprises a main shroud surface disposed on upstream of the shroud surface and extending in the virtual cylindrical surface coaxial with the spin axis of the storage disk.

6. The storage disk driving apparatus according to claim 5, wherein the shroud surface and the main shroud surface are a continuum.

7. The storage disk driving apparatus according to claim 5 further comprises a voice coil motor jointed with the carriage and a vent connected to an aisle defined by the main shroud surface and extending to the voice coil motor.

8. A casing of a storage disk driving apparatus for driving a storage disk comprising;
a main body;
a main shroud surface defined by the main body, the main shroud surface extending in a virtual cylindrical surface coaxial with a cylindrical space]; and
a shroud surface comprised of a plane surface extending in parallel with the axis of the virtual cylindrical surface while forming a continuum with the main shroud surface, and facing an outside surface of the virtual cylindrical surface.

9. The casing of a storage disk driving apparatus according to claim 8, wherein the plane surface meets the virtual cylindrical surface.

10. The casing of a storage disk driving apparatus according to claim 8, wherein the main shroud surface defines an opening.

11. The casing of a storage disk driving apparatus according to claim 10, wherein the plane surface meets the virtual cylindrical surface.
